(19) United States
(12) Patent Application Publication
(10) Pub. No.: US 2009/0322128 A1
(43) Pub. Date: Dec. 31, 2009

(54) Retrofit height adjustable seat

(76) Inventor: Dale A. Bell, Dayton, OH (US)

Correspondence Address: A PATENT LAWYER CORP, PLC;R WILLIAM GRAHAM, 22 S ST CLAIR ST, DAYTON, OH, 45402, US

(21) Appl. No.: 12/484,630

(22) Filed: Jun. 15, 2009

Related U.S. Application Data
(63) Continuation-in-part of application No. 12/146,574, filed on Jun. 26, 2008.

(51) Int. Cl. A47C 3/26; A47C 7/02; A47C 31/00; A47C 3/20; A62B 35/00

(52) U.S. Cl. 297/217.3; 297/339; 297/452.42; 297/217.1; 297/468; 297/344.12

(57) ABSTRACT

A retrofit height adjustable seat for a chair having a support frame having a base for connection to the support frame and a top seat frame include a displacement mechanism movably interconnecting the base, a rack operably connected to one of the base and top seat frame and pinion operably connected to the rack. The displacement mechanism includes a pair of interconnected scissor arms which in a retracted mode are in a generally parallel position relative to one another rendering the top seat frame seat adjacent the base and when in an extended mode are in a generally nonparallel position relative to one another rendering the top seat frame seat displaced away from the base.

This is a continuation-in-part to U.S. Ser. No. 12,146,574 filed Jun. 26, 2008.

### BACKGROUND OF INVENTION

1. Field of Invention

This invention concerns improvements in or relating to a retrofit height adjustable seat primarily for use on a chair and like apparatus for raising and lowering a seat of a chair.

2. Related Art

The present invention is an improvement over the teachings in U.S. Pat. No. 5,695,248 which pertained to a retrofit adjustable seat for connection to a conventional wheelchair having a frame, wheels, a wheelchair seat and back operably connected thereto. Such a seat comprised a base with releasable connector for connecting the base to the frame of the wheelchair, a retrofit seat, and an elevator operably connecting the base and the retrofit seat for adjustably elevating the retrofit seat to a selectable height.

Even with the improvements made to the art, the prior invention did not lend itself to ready use on various types of chairs and there remained a need to improve the art. Further, there is a need for a retrofit height adjustable seat for a chair which allows for easy collapsible operation and ease of use for various types of chairs.

### BRIEF SUMMARY OF INVENTION

It is an object to improve retrofit height adjustable seats.

It is another object to provide an improved retrofit height adjustable seat for a chair with improved stability.

It is yet another object to provide improved strength and weight capacity while minimizing weight of a retrofit height adjustable seat for a chair.

Accordingly, the invention is directed to a retrofit height adjustable seat for a chair with an improved elevating mechanism. The seat includes a base for connection to a support frame of the chair, a top seat frame movably connected to the base by a displacement mechanism which includes a rack operably connected to one of the base and top seat frame and pinion operably connected to the rack. The displacement mechanism can include a pair of interconnected scissor arms which in a retracted mode are in a generally parallel position relative to one another rendering the top seat frame seat adjacent the base and when in an extended mode are in a generally nonparallel position relative to one another rendering the top seat frame seat displaced away from the base. Preferably, there are provided at least two sets of scissor arms which are displaced from each other and interconnect the top seat frame and the base. At least one of the scissor arms, and preferably two, is connected to the pinion and rack. An actuator which can preferably be motorized interconnects the scissor arms to move the scissor arms between the retracted and extended modes. The two pair of scissor arms can preferably be oriented in generally symmetrically opposing relation wherein each arm has an end which opposes an end of an opposing arm and to which is interconnected by way of a rigid shaft.

### BRIEF DESCRIPTION OF DRAWINGS

FIG. 1 is a perspective view of a retrofit height adjustable seat featuring the present invention.

FIG. 2a is a perspective view of a chair frame with the retrofit height adjustable seat featuring the implementation of a mode of use of the present invention.

FIG. 2b is a perspective view of a chair frame with the retrofit height adjustable seat connected thereto.

FIG. 3 is a perspective view of another embodiment retrofit height adjustable seat of the present invention emphasizing arm swivel and movement.

FIG. 4 is a perspective view of a bracket in the present invention.

FIG. 5 is a perspective view of another mode of use showing a collapsed form for mobility and storage for the retrofit height adjustable seat of the present invention.

FIG. 6 is a perspective view of elastic members of the present invention.

FIG. 7 is a perspective view of a displacement mechanism of the instant invention in a retracted mode.

FIG. 8 is a perspective view of a displacement mechanism of the instant invention in a displaced mode.

FIG. 9 is a perspective view of a part of the invention.

FIG. 9A depicts use of the invention in another mode.

FIG. 9B depicts a blow up portion of 9A in cross section.

FIG. 10 depicts a scissor arm of the invention.

### DETAILED DESCRIPTION OF THE INVENTION

Referring to the drawings, a retrofit height adjustable seat is generally designated by the number 10. The retrofit height adjustable seat 10 includes a base 12 which can be connected to support frame members 14 of a wheelchair 16 through use of brackets 18 and elastic members 28 which fixably connect the base 12 to the support frame members 14. The brackets 18 may be formed of any resilient and strong material, preferably a light weight metal, aiding ease of portability along with strength. It is also contemplated that the brackets 18 can be integrally formed as part of the base 12 or removably positionably connected thereto.

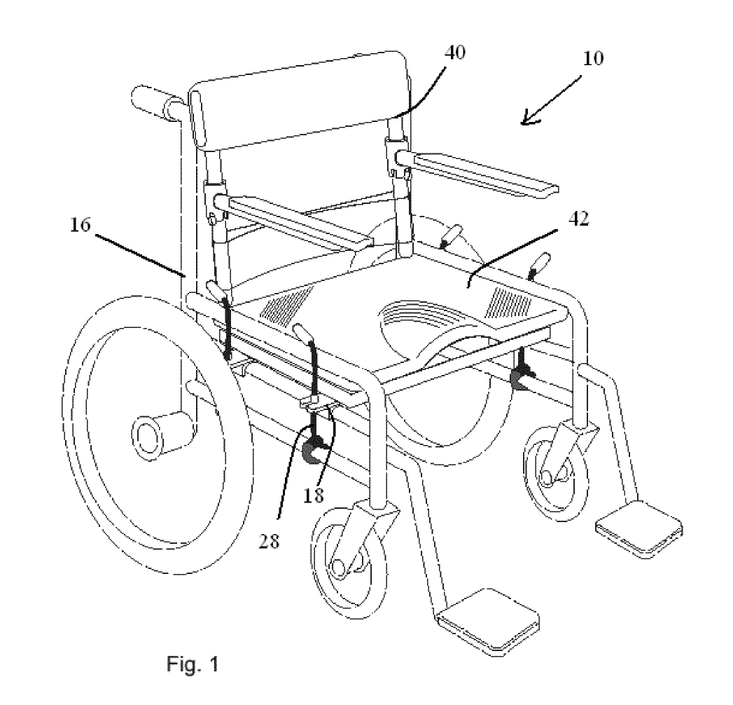

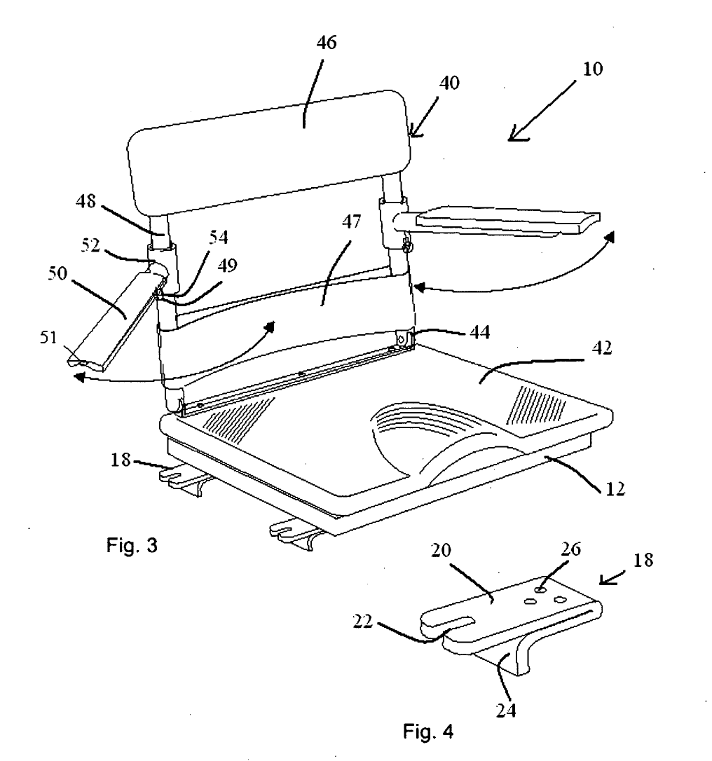

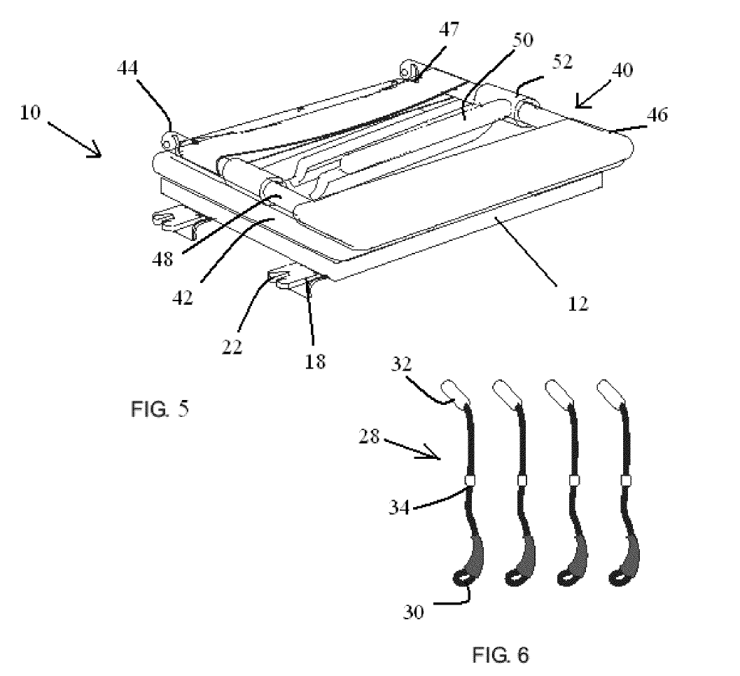

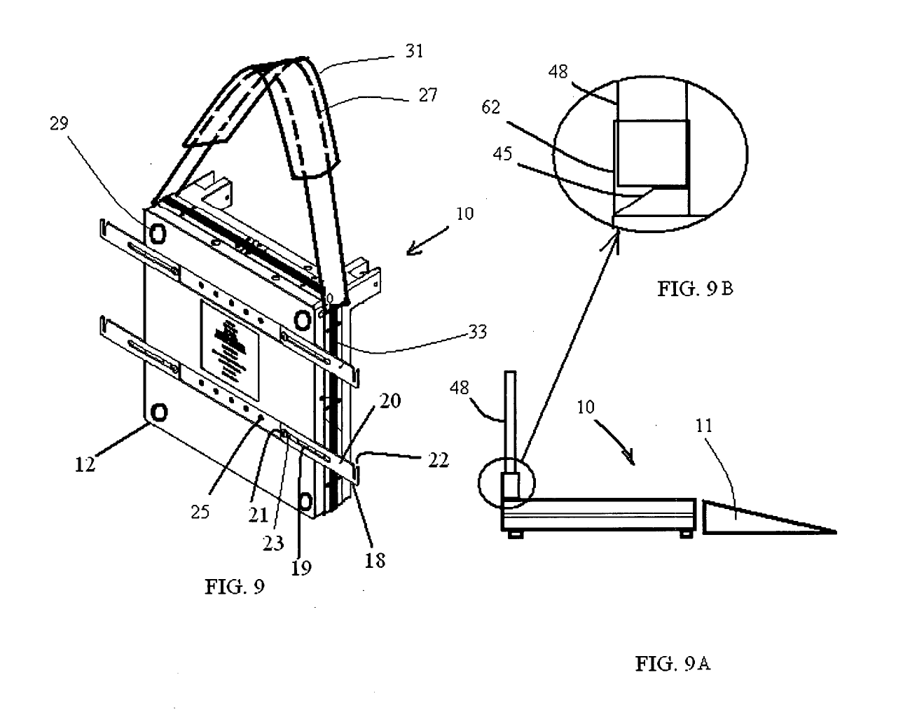

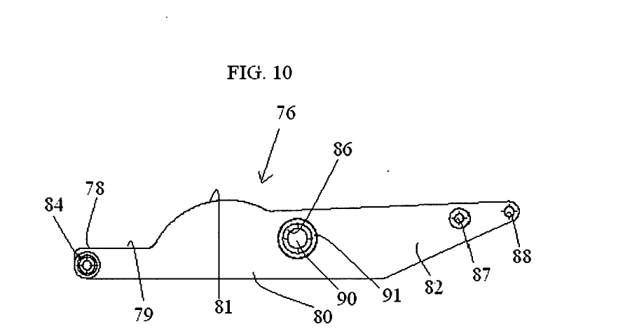

FIGS. 1-5 depict the brackets 18 as having a generally planar and elongated surface portion 20 having a notch 22 formed in an end thereof, and an angle stop portion 24 is connected to portion 20. FIGS. 8 and 9 depict the brackets 18 with a slightly difference configuration wherein notch 22 is formed in a lateral portion of thereof. As seen in FIG. 9, the brackets 18 can be connected to base 12 by way of a slot 19 formed in the bracket 18 and use of screws 21 formed in threaded surfaces 23 in base 12. A series of vent openings 25 which can preferably be configured with a filter are formed in the back of the base 12 which provide air flow to permit bellows 33 to intake and exhaust and yet prevent debris and fluid from entering therein. For FIGS. 1-5, base connection interface is achieved through the use of openings 26 in bracket 18 and screws (not shown) which secure the brackets 18 to the base 12. It is contemplated that other means for connection between the base 12 and brackets 18 can be employed. By way of example, there are four brackets 18 employed, but the number and position can be varied to accommodate the seat/chair combination. A seat belt 27 can be removably connected to the base 12 and can be provided with padding 31 to serve as shoulder padding in the event of carrying the seat 10 or as waist padding when worn.

Provided are a plurality of floor pads 29 which can be used when disposing the seat 10 directly on a floor for example. The pads 29 should be of a height sufficient to provide some ground clearance for the base 12 and brackets 18. In this regard, FIG. 9A shows the seat 10 generally and can be disposed on the ground adjacent a ramp 11 which can be used to slide a person lying on the ground onto the seat 10 and then the person can be subsequently elevated.

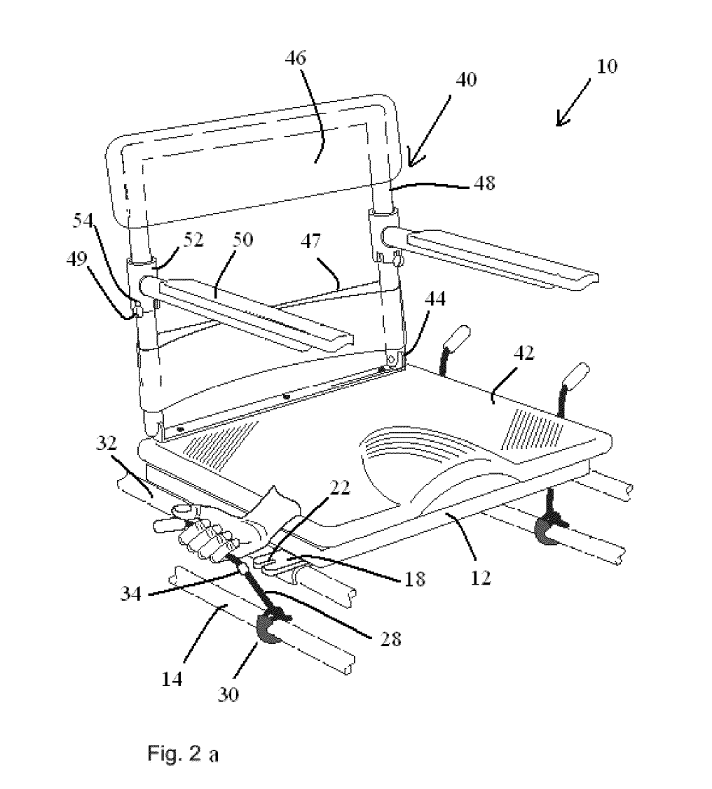

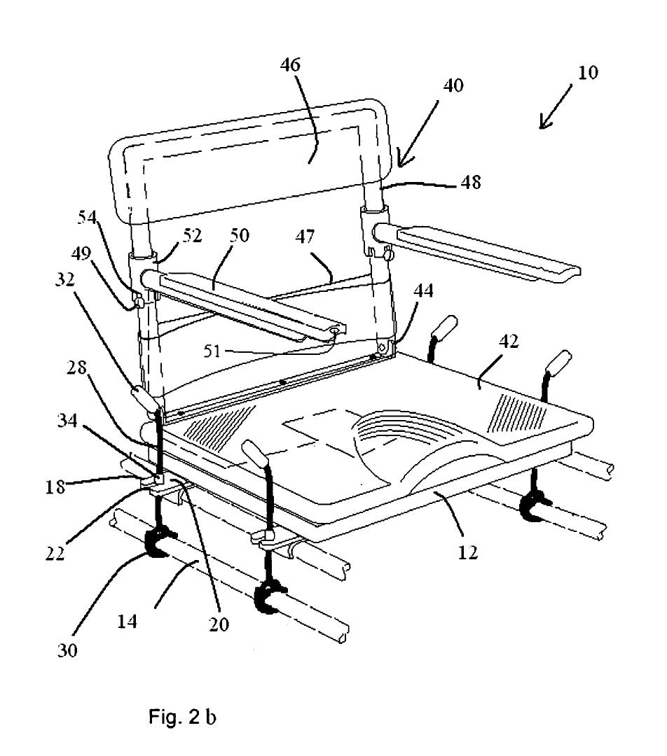

FIG. 6 thus shows four elastic members 28 for use with brackets 18, wherein each elastic member 28 includes a looped end 30, a handle end 32 and an a fixably adjustable piece 34, such as a malleable ring of copper, for example, disposed about the elastic member 28. Looped end 30 can be connected about the support frame 14 as seen in FIGS. 1 and 2 with the handle end 32 inserted through the looped end 30 thereby encircling the support frame 14. Elastic member 28 has a diameter to fit within notch 22. Handle end 32 can be used to pull and create tension and elastic member 28 can be inserted through the bracket notch 22.

Thus, as handle end 32 is pulled, the elastic member 28 is under tension and with the adjustable piece 34 held above the notch 22 and in contact with portion 20, the piece 34 can be fixed to the elastic member 28 (e.g., by crimping copper ring) such that a point of connection is created with the bracket 18 whereby the base 14 is forcibly held to the support frame 14 through the tension of the elastic member 28 and described interconnection. The brackets 18 can preferably be commonly positioned in symmetric manner about the base 12 or as otherwise may be conducive to permit the elastic members 28 to be connected to the support frame 14.

A collapsible seat back 40 is hingedly connected to a seat 42 which is movably connected to base 12 by a displacement mechanism 60 described in hereinafter. The seat back 40 will allow the retrofit height adjustable seat 10 to collapse and fold in a compact manner.

FIGS. 1-5 depict one version of a limiting hinge mechanism 44 which provides for the seat back 40 to move between an upright or normal position and a collapsed or folded position whereupon the seat back 40 is folded flat against the seat 42. The seat back 40 has upper transverse support pad 46 and lower lumbar strap 47 interconnecting side frame members 48. Alternatively, a limit hinge mechanism 44′ as seen in FIGS. 8 and 9 provide two upward extending side members 62 and 64 and front upward extending member 66 having a semi-circular notch 67 to receive side frame member 48 when seat back 40 is in its folded position. The side frame members 48 can be connected via a hinge pin 69 which is driven through coaxially aligned open surfaces of the side frame members 48 and upward extending side members 62 and 64. The front upward member 66 acts as a brace to limit travel of the side frame members 48 once in the unfolded position. The back of hinge mechanism 44′ remains open to permit the side frame members 48 to rotate about the pin 49. FIG. 9B depicts a blow up portion of FIG. 9A in cross-section which reveals a truncated ramp 45 which serves a locking surface for end of frame members 48.

Pivoting arms 50 can preferably be axially movable on the seat back frame members 48 and include a T-shaped tubular connector 52 which includes a plurality of radially spaced notches 54 to receive a pin 49 which extends outward from the frame member 48. The arms 50 can thus move axially free of the pin 49 and notch 54 connections so that the arms 50 are free to rotate about the frame members 48. The arms 50 can pivot to lie flat and in generally the same plane as a plane spanned by the seat back 40. Also, each pivoting arm 50 can be provided onto pin 49 via notch 54 in connector 52 to provide for various fixed arm widths enabling use of various sized users.

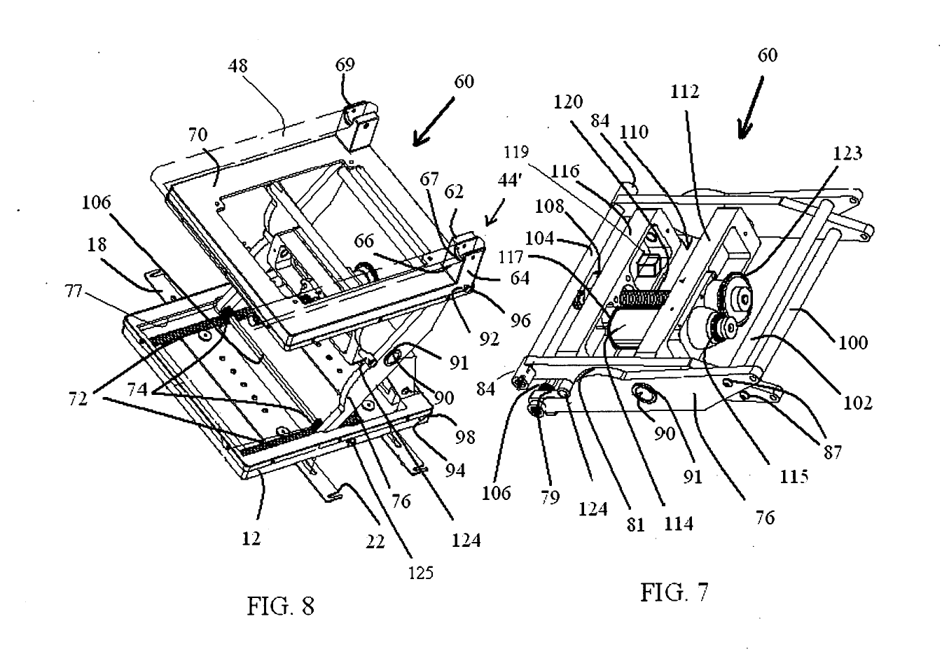

A preferred displacement mechanism 60 of the instant invention is an improvement over the art. The base 12 connects to support frame members 14. A top seat frame 70 is movably connected to the base 12 by a displacement mechanism 60 which includes at least one and here shown two racks 72 operably connected to base 12 and pinions 74 operably connected to the racks 72. The displacement mechanism 60 can include a pair of interconnected scissor arms 76 which in a retracted mode are in a generally parallel position relative to one another as seen in FIGS. 7 and 9 rendering the top seat frame seat 70 adjacent the base 12 and when in an extended mode are in a generally nonparallel position relative to one another as seen in FIG. 8 rendering the top seat frame seat 70 displaced away from the base 12.

Preferably, there are provided at least two pair of scissor arms 76 which are laterally displaced on from each other and interconnect the top seat frame 70 and the base 12. Each scissor arm 76 includes a first end 78 including a first ramp bearing surface 79, an inner portion 80 including an arcuate ramp bearing surface 8land a second end 82. End 78 includes a cross bar receiving surface 84, inner portion 80 includes a pin receiving surface 86 and end 82 includes cross bar receiving surface 87 and mounting surface 88. The scissor arms 76 are configured to minimize space requirements while achieving necessary height requirements. In this regard, the end 82 is tapered and arcuate ramp bearing surface 81 aids to accomplish this requirement. Each pair of cooperating scissor arms 76 are connected by a pin 90 extending through pin receiving surface and retaining rings 91 which are forcibly disposed about end of the pin 90 to retain the scissor arms 76 together. Ends 82 are disposed adjacent the rear of both top seat frame 70 and base 12 such that mounting surfaces 88 can be disposed in coaxial alignment with pin receiving surface 92 and 94 of respective top seat frame 70 and base 12 to receive retention pins 96 and 98 respectively. Additionally, cross bars 100 and 102 interconnect opposing cross bar receiving surfaces 87 of respective opposing arms 76 as can be seen in FIG. 7, for example. Opposing cross bar receiving surfaces 84 of ends 82 of opposing arms 76 which are movably disposed adjacent top seat frame 70 receive a cross bar 104. Opposing cross bar receiving surfaces 84 of ends 82 of opposing arms 76 which are movably disposed adjacent base 12 receive a shaft 106 and also receive pinions 74 thereon. Further, inner shelves 77 connect inside the base 12 and seat frame 70 to form a retaining track for the cross bar receiving surfaces 84 which protrude outward from arms 76. FIG. 8 shows shelf 77 on base 12 and it is to be understood that another like shelf 77 is formed similarly on top seat frame 70 although not shown. This configuration enables relative planar stability between the base 12 and top seat frame 70 as they laterally displace from one another. The arms 76 and surfaces 84 can preferably be made of a self lubricating plastic to aid in movement of parts. The cross bars 100, 102, 104 and 106 serve to stabilize the arms 76 when moving between up and down positions. The cross bar 106 interconnects pinions 74 preferably in a fixed manner to provide synchronized rotation of the pinions 74 thereby minimizing twisting of the other parts. The cross bar 106 can be made of a rigid material, preferably metal to better enable function with the racks 72 and pinions 74, while cross bars 100, 102 and 104 can be of a suitable rigid material which aids in stability as well as decreases cost and weight, such as plastic or metal. The racks 72 and pinions 74 serve to aid control of and assure maintaining a desired distance of travel for the arms 76. Here are shown two pair of the scissor arms 76 connected at one end 78 thereof to the pinions 74 and racks 72. The use of the racks 72 and pinions 74 guard against structural twisting which might otherwise occur from uneven weight loads. The two pair of scissor arms 76 can preferably be oriented in generally symmetrically opposing relation wherein each arm 76 has end 82 and 84 opposing end 82 and 84, respectively of an opposing arm 76.

An actuator 110 can preferably include a motor mount 112 which interconnects inwardly disposed scissor arms 76 via pins 90 which extend laterally outward from mount 112 through inwardly and outwardly disposed arms 76 to be retained by rings 91. A motor 114 is operably connected to motor mount 112. An emergency shut off switch 51 is operably connected to the arm 50 and displacement mechanism 60 such that motor 114 can be stopped for example. A processor controller 119 having operable software therewith is operably connected to switch 51 and displacement mechanism 60 which includes redundant travel limit switches to operate the same and also equipped to record and store up/down cycle information for product evaluation. A stop pin 125 limits travel of pinions 74 and serves as a safety stop mechanism. The motor 114 includes a drive shaft and gear 115 connected thereto. A noise shield 117 is operably disposed about the motor 114 to prevent electrical interference from occurring with other electrical equipment which may exist in a hospital environment. In this regard, wires connecting to the motor can include a ferrite bead insulator to further suppress noise. A screw assembly mount 116 also interconnects the inwardly disposed scissor arms 76 and has a screw assembly 118 operably connected thereto which includes a threaded shaft 120 threaded to a fixed threaded surface 122 on the mount 116 and is rotatably movably mounted to mount 112. Shaft a gear 123 which is retained in operably movable connected position with gear 115. Mount 116 includes laterally extending bearing pins 124 which extend outwardly and in a manner to movably contact ramp bearing surfaces 79 and 81 and can easily traverse self lubricating plastic arms 76. Thus, as the motor gear 115 turns gear 123, the screw 120 turns within fixed threaded surface 122 which in turns causes the mount 116 to be axially displaced toward or away from the mount 112 as a function of the rotation of gear 115. Also, the pins 124 which bear upon the ramp bearing surfaces 79 and 81 in turn cause the arms 76 to moved between the retracted (arms 76 generally parallel) and extended modes (arms 76 crossed and non parallel).

While the present invention has been set forth above in a preferred embodiment, it is contemplated that other modifications, improvements and derivations will be readily apparent to those skilled in the art. For example, it is contemplated that the elastic base end could be alternatively designed to connect to the base of the seat, such that handle end is looped under the chair support frame and the elastic member can be brought into a notch on such bracket. Accordingly, the appended claims hereto should be accorded the full scope of protection of any such modifications, improvements and derivations.

What is claimed is:

1. A retrofit height adjustable seat for a chair having a support frame having a base for: connection to the support frame and a top seat frame, the improvement which includes:
a displacement mechanism movably interconnecting the base and the top seat frame, a rack operably connected to one of the base and top seat frame and pinion operably connected to the rack.

2. The retrofit height adjustable seat of claim 1, wherein said displacement mechanism includes at least a pair of interconnected scissor arms which in a retracted mode are in a generally parallel position relative to one another rendering the top seat frame seat adjacent the base and when in an extended mode are in a generally nonparallel position relative to one another rendering the top seat frame seat displaced away from the base.

3. The retrofit height adjustable seat of claim 2, which includes at least two pair of said scissor arms which are displaced from each other in an opposing relation and interconnect the top seat frame and the base.

4. The retrofit height adjustable seat of claim 2, wherein at least one of said scissor arms is connected to said pinion and said rack.

5. The retrofit height adjustable seat of claim 3, which is further characterized to include two racks disposed in generally opposing relation and two pinions, wherein each said pinion is in operable connection to one said rack and wherein at least one opposing arm of each pair of said scissor arms is operably connected to one said pinion and said rack.

6. The retrofit height adjustable seat of claim 2, which includes an actuator operably interconnecting said scissor arms to move said scissor arms between said retracted mode and said extended mode.

7. The retrofit height adjustable seat of claim 3, wherein said two pair of scissor arms are oriented in generally symmetrically opposing relation and wherein each arm has an end which opposes an end of an opposing arm and to which is interconnected by way of a rigid cross shaft.

8. The retrofit height adjustable seat of claim 2, wherein scissor arms include an arcuate bearing surface.

9. The retrofit height adjustable seat of claim 2, wherein scissor arms include a tapered end.

10. The retrofit height adjustable seat of claim 1, which includes a bracket connected to the base; and an elastic member removably connected to said bracket and for interconnecting the base to the support frame, thereby positionably securing the seat to the support frame.

11. The retrofit height adjustable seat of claim 1, which further includes a collapsing seat back connected to the top seat frame.

12. The retrofit height adjustable seat of claim 11 which further includes fixably adjustable arms connected to said collapsing seat back.

13. The retrofit height adjustable seat of claim 10, wherein said bracket includes a notch to removable receive said elastic member.

14. The retrofit height adjustable seat of claim 10, wherein said elastic member includes a base end for connection to the support frame, a handle end, and a fixably adjustable piece between said ends wherein said fixably adjustable piece provides a point of connection to said bracket and when said base end is connected to the support frame and said fixably adjustable piece is connected to said bracket, said elastic member is under tension to positionably retain said base to said support frame.

15. A retrofit height adjustable seat for a chair having a support frame, which includes:
a base for connection to the support frame;
a top seat frame; and
a displacement mechanism movably interconnecting said base and said tope seat frame, a rack operably connected to one of said base and said top seat frame and pinion operably connected to said rack.

16. The retrofit height adjustable seat of claim 15, wherein said displacement mechanism includes at least a pair of interconnected scissor arms which in a retracted mode are in a generally parallel position relative to one another rendering said top seat frame seat adjacent said base and when in an extended mode are in a generally nonparallel position relative to one another rendering the said seat frame seat displaced away from said base.

17. The retrofit height adjustable seat of claim 16, which includes at least two pair of said scissor arms which are displaced from each other in an opposing relation and interconnect said top seat frame and said base.

18. The retrofit height adjustable seat of claim 16, wherein at least one of said scissor arms is connected to said pinion and said rack.

19. The retrofit height adjustable seat of claim 17, which is further characterized to include two racks disposed in generally opposing relation and two pinions, wherein each said pinion is in operable connection to one said rack and wherein at least one opposing arm of each pair of said scissor arms is operably connected to one said pinion and said rack.

20. The retrofit height adjustable seat of claim 16, which includes an actuator operably interconnecting said scissor arms to move said scissor arms between said retracted mode and said extended mode.

21. The retrofit height adjustable seat of claim 17, wherein said two pair of scissor arms are oriented in generally symmetrically opposing relation and wherein each arm has an end which opposes an end of an opposing arm and to which is interconnected by way of a rigid cross bar.

22. The retrofit height adjustable seat of claim 16, wherein scissor arms include an arcuate bearing surface.

23. The retrofit height adjustable seat of claim 16, wherein scissor arms include a tapered end.

24. A retrofit height adjustable seat for a chair having a support frame having a base for connection to the support frame and a top seat frame and having a displacement mechanism movably interconnecting the base and the top seat frame, the improvement which includes:
bellows inter connecting the base and the top seat frame to form and enclosure therebetween and a plurality of filtered vents formed in the seat to provide restricted flow therethrough.

25. A retrofit height adjustable seat for a chair having a support frame having a base for connection to the support frame and a top seat frame and having a displacement mechanism movably interconnecting the base and the top seat frame, the improvement which includes:
an electric motor which includes a noise shield formed thereabout to minimize electrical noise interference.

26. The retrofit height adjustable seat of claim 25 which further includes an electrical shield about wiring connected to said motor to further minimize electrical noise.

27. The retrofit height adjustable seat of claim 2, wherein said base and said top seat frame each include a track and said arms include an outwardly extending slide member which is slidably retained within one of said tracks.

28. The retrofit height adjustable seat of claim 27, which includes a stop pin formed in at least one of said tracks to limit movement of at least one of said slide members.

29. The retrofit height adjustable seat of claim 2, wherein said arms are made of a self lubricating plastic.

30. A retrofit height adjustable seat for a chair having a support frame having a base for connection to the support frame and a top seat frame and having a displacement mechanism movably interconnecting the base and the top seat frame, the improvement which includes:
an operably associated ramp of a height approximate that of a height the seat for disposal adjacent thereto to aid in sliding a person onto the seat.

31. The retrofit height adjustable seat of claim 31, which further includes a plurality of pads formed on the base of a height to provide ground clearance for the base when the seat is disposed on the ground.

32. A retrofit height adjustable seat for a chair having a support frame having a base for connection to the support frame and a top seat frame and having a displacement mechanism movably interconnecting the base and the top seat frame, the improvement which includes:
a belt which connects to the seat and is configured to perform as one of a shoulder carrying strap and a seat belt.

33. The retrofit height adjustable seat of claim 32, which further includes padding formed about the belt.
a rack operably connected to one of the base and top seat frame and pinion operably connected to the rack.

34. A retrofit height adjustable seat for a chair having a support frame having a base for connection to the support frame and a top seat frame and having a displacement mechanism movably interconnecting the base and the top seat frame, the improvement which includes:
a seat back hingedly connected to the top seat frame in a manner to lock in place when disposed in a normal and generally erected position with respect to the top seat frame.
